(19) United States
(12) Patent Application Publication
(10) Pub. No.: US 2026/0002807 A1
(43) Pub. Date: Jan. 1, 2026

(54) TUBE ARRANGEMENT POLISHED BY FORCED ELECTROLYTIC PLASMA POLISHING IN SECTIONS, IN PARTICULAR A MEASURING TUBE ARRANGEMENT, MEASURING SENSOR WITH SUCH A MEASURING TUBE ARRANGEMENT, AND METHOD FOR PLASMA POLISHING A MEASURING TUBE ARRANGEMENT

(71) Applicant: Endress+Hauser Flowtec AG, Reinach (CH)

(72) Inventors: Julien Zimmermann, Neuenhof (CH); Lisa Zwittnig, Basel (CH); Yannick Populus, Steinbrunn-Le-Bas (FR)

(21) Appl. No.: 18/872,149

(22) PCT Filed: May 31, 2023
(86) PCT No.: PCT/EP2023/064518

§ 371 Date: Dec. 5, 2024

(30) Foreign Application Priority Data
Jun. 13, 2022 (DE) 10 2022 114 829.7

(51) Int. Cl. G01F 1/84; C25F 3/16; H05H 1/48

(52) U.S. Cl. CPC G01F 1/8409; C25F 3/16; G01F 1/8404; G01F 1/8495; H05H 1/48; H05H 2245/40

(57) ABSTRACT

A measuring tube arrangement has two support bodies, each with at least one bore, and a measuring tube with a lumen for guiding a medium. The measuring tube has a first end portion and a second end portion which are each connected to one of the support bodies. The tube arrangement has a portion that is polished by forced electrolytic plasma polishing that extends over at least three diameters of the tube. The portion polished by forced electrolytic plasma polishing is followed by an etched portion having a different surface structure than the portion polished by forced electrolytic plasma polishing.

The present invention relates to a tube arrangement polished by forced plasma polishing in portions, in particular a measuring tube arrangement, measuring sensor with such a measuring tube arrangement, and method for plasma polishing a tube arrangement, in particular measuring tube arrangement.

A generic tube arrangement, in particular a measuring tube arrangement, comprises two support bodies, each with at least one bore; and at least one tube, in particular a measuring tube, with a lumen for guiding a medium, wherein end portions of the at least one measuring tube are each connected to one of the support bodies, wherein at least one end portion of the tube, in particular the measuring tube, is plasma-polished.

A method and a polishing head for plasma polishing of tubes are described in the published patent application DE 2016 100 558 A1, wherein the polishing head, which is arranged coaxially to the tube and serves as a cathode and is continuously supplied with an electrolyte, is moved through the tube for polishing. Chinese Utility Model CN 2020 72789 U discloses a device for electropolishing the inner wall of thin tubes, in which a cathode wire is guided along the tube axis and an electrolyte is pumped through the tube to generate the plasma. However, these approaches prove to be problematic, particularly for tubes with small diameters or for curved measuring tubes, since centering the cathode is difficult and in addition the available volume for forming the plasma layer and supplying the electrolyte is further limited. Insofar as the bending of the measuring tubes or the joining of the end portions of the measuring tubes with the support bodies leads to impairments of the surface properties of the measuring tubes in the affected regions, a post-treatment of the surfaces is advisable in order to restore the surface quality. It is therefore the object of the present invention to remedy this situation, wherein the solution sought should be suitable in the sense of a standardization of industrial processes regardless of the tube shape, i.e., not only for bent tubes or measuring tubes.

The object is achieved in accordance with the invention by the tube arrangement according to claim 1, the measuring sensor according to claim 6, and the method according to claim 8.

The tube arrangement according to the invention, in particular the measuring tube arrangement, comprises two support bodies, each with at least one bore; and at least one tube, in particular measuring tube, with a lumen for guiding a medium, wherein end portions of the at least one tube, in particular measuring tube, are each connected to one of the support bodies, wherein the bores of the support bodies communicate with one another via the lumen of the tube, in particular measuring tube,
wherein the measuring tube arrangement has a portion which is polished by forced electrolytic plasma polishing and which, in a region in which the flow cross section comprises not more than the cross section of the at least one tube, in particular of the measuring tube, extends over at least three, in particular at least four, diameters of the at least one tube, in particular of the measuring tube, wherein the portion polished by forced plasma polishing is followed by an etched portion, wherein the etched portion has a different surface structure from the portion polished by forced plasma polishing.

In a development of the invention, the etched portion comprises an electropolished surface which has a greater roughness than the forced plasma-polished surface of the first portion.

In a development of the invention, the portion polished by forced plasma polishing has a surface roughness which is not more than Ra=0.4 μm, in particular not more than Ra=0.3 μm.

The tube, in particular the measuring tube, has a metal structure, wherein in a development of the invention the etched portion has a surface structure in which grain boundaries of the metal structure are etched free.

In a development, the tube, in particular the measuring tube, has a curved course at least in portions with at least one arc, which in particular covers an angle of not less than 20°, in particular not less than 30°, wherein the arc has, for example, a radius of curvature of not more than 10, in particular not more than 6, inner diameters of the tube, in particular the measuring tube, wherein the arc has, for example, a radius of curvature of not more than 10, in particular not more than 6, inner diameters of the tube, in particular the measuring tube, wherein the portion polished by forced plasma polishing comprises the at least one arc over at least half the length of the at least one arc, in particular over at least two thirds of the length of the at least one arc.

In a development of the invention the inner diameter of the tube, in particular measuring tube, is not more than 30 mm, for example not more than 15 mm, and, in particular not more than 10 mm.

The measuring sensor according to the invention comprises a measuring tube arrangement according to the invention, a base body which rigidly connects the two support bodies to one another, an electrodynamic exciter for exciting bending vibration modes, at least one vibration sensor for detecting bending vibrations of the measuring tube.

In a development of the invention, the measuring tube arrangement of the measuring sensor comprises two parallel measuring tubes, wherein the electrodynamic exciter is designed to excite bending vibrations in at least one bending vibration mode between the measuring tubes, and wherein the at least one vibration sensor is designed to detect bending vibrations between the measuring tubes.

The method according to the invention for portion-wise plasma polishing of a measuring tube arrangement comprises:

positioning a cathode and an electrolyte supply line with respect to a measuring tube arrangement, wherein the cathode has a tip which is spaced no more than four, for example no more than two and in particular no more than one, inner diameter of a tube, in particular measuring tube of the measuring tube arrangement, from an end face of the measuring tube arrangement;
allowing an electrolyte to flow through the measuring tube arrangement;
and applying an electrical polishing voltage between the cathode and the measuring tube arrangement which is sufficient to maintain a plasma in a portion of the measuring tube arrangement which extends from an end face of the measuring tube arrangement over a length of not less than four, in particular not less than six, and preferably not less than eight, inner diameters of the tube, in particular measuring tube, into the measuring tube arrangement,
wherein the measuring tube arrangement comprises two support bodies, each with at least one bore; and at least one tube, in particular measuring tube, with a lumen for guiding a medium, wherein end portions of the at least one tube, in particular measuring tube, are each connected to one of the support bodies, wherein the bores of the support bodies communicate with one another via the lumen of the tube, in particular measuring tube, wherein at least one end portion of the tube, in particular measuring tube, is polished by forced plasma polishing.

In a development of the invention, the electrolyte has a volume flow rate per cross-sectional area of the measuring tube arrangement through which a flow can pass that is not less than 0.1 l/(min·cm²), for example not less than 0.2 l/(min·cm²) and in particular not less than 0.3 l/(min·cm²).

In a development of the invention, the electrolyte has a volume flow rate per cross-sectional area of the measuring tube arrangement through which a flow can pass that is not more than 4 l/(min·cm²), for example not more than 2 l/(min·cm²) and in particular not more than 1 l/(min·cm²).

By allowing the electrolyte to flow, waste products of the polishing process are efficiently transported away from forced plasma-polished surface portions of the measuring tube arrangement, and gas bubbles that prevent the plasma from being maintained are flushed away.

In a development of the invention, the applied polishing voltage is not less than 250 V, in particular not less than 300 V. Furthermore, according to a development of the invention, the applied polishing voltage is not more than 500 V, in particular not more than 400 V.

In a development of the invention, the electrolyte comprises ammonium sulfate and optionally sulfuric acid.

In a development of the invention, the plasma is maintained, when electrolyte is flowing, for a time period of not less than 2 minutes, in particular not less than 3 minutes.

In a development of the invention, the plasma is maintained, when electrolyte is flowing, for a time period of not more than 10 minutes, in particular not more than 6 minutes.

In a development, the measuring tube arrangement is completely filled with the electrolyte during the plasma polishing. Complete filling with electrolyte may also include gas loading of the electrolyte or loading of the electrolyte with solids.

In a development of the invention, the electrolyte comprises ammonium sulfate and possibly sulfuric acid.

In a development, the electrolyte has a conductivity of not more than 500 S/cm in particular not more than 400 mS/cm and preferably not more than 350 mS/cm.

The invention is now explained in more detail on the basis of the exemplary embodiments shown in the figures.

In the drawings:

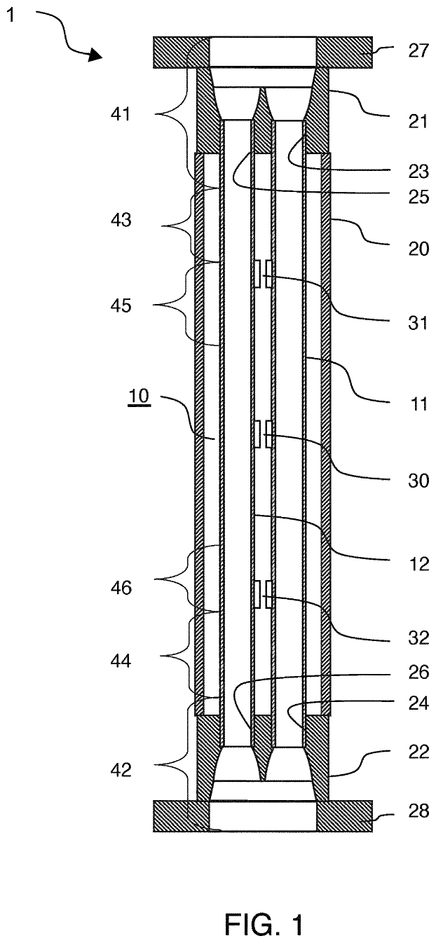

FIG. 1: shows a schematic sectional view of an embodiment of a measuring sensor according to the invention with an embodiment of a measuring tube arrangement according to the invention;

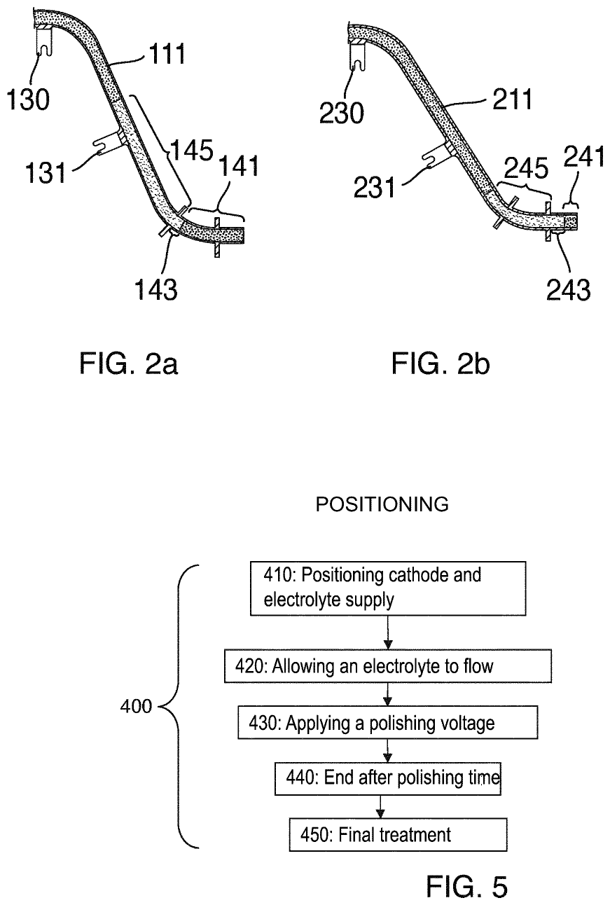

FIG. 2a shows a sectional view of a measuring tube that was treated with a plasma polishing process according to the invention;

FIG. 2b: shows a cross-sectional view of a measuring tube that was treated with a conventional plasma polishing process;

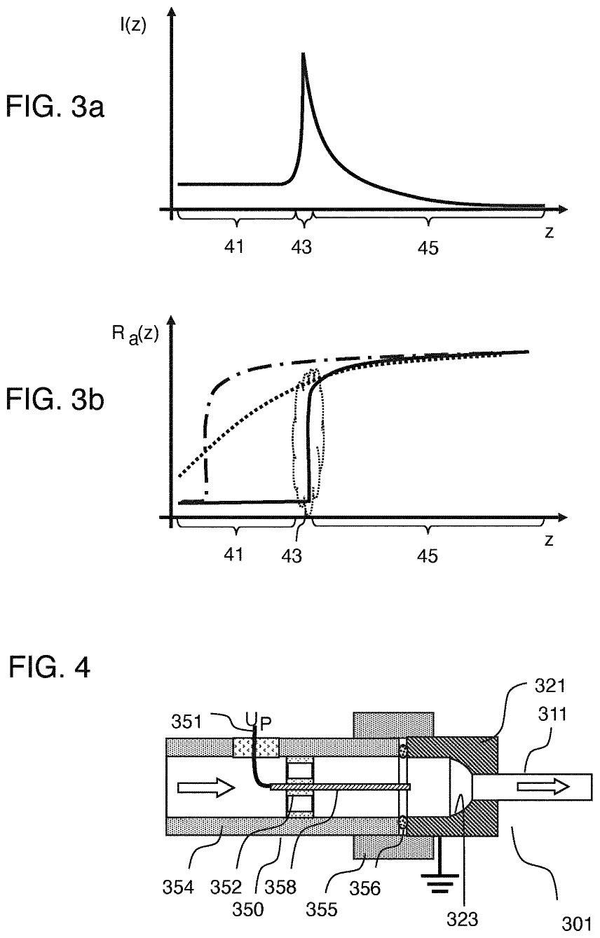

FIG. 3a: shows a schematic graph of a current density distribution, by way of example, in the longitudinal direction of a measuring tube portion during the implementation of the method according to the invention;

FIG. 3b: shows a graph of the surface roughness of a measuring tube assembly treated according to the invention compared to measuring tube assemblies treated by prior art methods;

FIG. 4: shows a schematic view of an embodiment by way of example of an arrangement for implementing the method according to the invention;

FIG. 5: shows a flow diagram for implementing the method according to the invention.

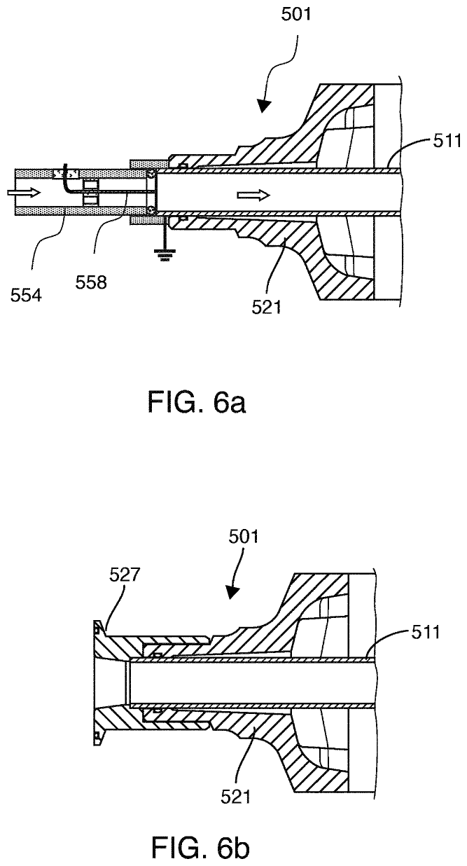

FIG. 6a: shows a schematic view of a second embodiment of an arrangement for implementing the method according to the invention; and

FIG. 6b: shows a schematic view of a portion of a measuring sensor with a flange mounted after the plasma polishing.

The measuring sensor 1 shown in FIG. 1 for measuring one or more measured variables selected from mass flow rate, density and viscosity of a medium comprises a measuring tube arrangement 10, which here has two-here straight-measuring tubes 11, 12 and two support bodies 21, 22. The support bodies, which serve here as distributor pieces, each comprise through-bores 23, 24, 25, 26, wherein the measuring tubes 11, 12 are each fixed with their two end portions in one of the bores 23, 24, 25, 26, for example by joining, such as welding or soldering, rolling, pressing, screwing or gluing or by combinations of the aforementioned methods. The bores are shown here only schematically. Their concrete form results from fluidic considerations which are not of interest in the context of the present invention. In this embodiment, a process connection, here a flange 27, 28, is attached to the support bodies 21, 22 for mounting the measuring sensor in a pipeline through which the medium to be measured flows. The flanges 27, 28 are mounted in particular after the forced plasma polishing. The measuring sensor further comprises a base body 20, by means of which the two support bodies 21, 22 are rigidly connected to one another in order to suppress vibrations between the support bodies at least in the range of the natural frequencies of the bending vibration modes or torsional vibration modes of the measuring tubes 11, 12, which are to be evaluated in order to determine the measured variables of the measuring sensor 1. The measuring sensor further comprises an electrodynamic exciter 30 which acts between the measuring tubes 11, 12 in order to excite in particular bending vibration modes between the measuring tubes 11, 12, and two electrodynamic vibration sensors 31, 32 in order to detect bending vibrations between the measuring tubes 11, 12.

According to the invention, the measuring tube arrangement 10 has end portions 41, 42 polished by forced plasma polishing, which extend from the end faces of the measuring tube arrangement 10 facing away from the measuring tubes, through the bores 23, 24, 25, 26 of the support bodies 21, 22, into the measuring tubes 11, 12. The forced plasma-polished end portions 41, 42 are each followed by an etched portion 43, 44, which here extends over a length of several measuring tube diameters, with the etched portions 43, 44 merging into electropolished portions 45, 46. The surface properties of the individual portions are explained below.

As shown in FIG. 2a on the basis of a detailed view of a longitudinal section of half a measuring tube 111 of a further embodiment, the measuring tubes can, unlike in the embodiment according to FIG. 1, have a curved course in the rest position. The measuring tube 111 shown in FIG. 2a has an exciter holder 130 for an electrodynamic exciter in the apex of a central measuring tube bend, wherein a measuring tube cross-sectional plane runs through the holder 130, to which plane the measuring tube 111 has a mirror-symmetrical course. The measuring tube arrangement further comprises two electrodynamic vibration sensors (not shown here), which are arranged symmetrically to the measuring tube cross-sectional plane, and of which a first sensor holder 131 for holding a first of the electrodynamic vibration sensors is shown in FIG. 2a. The measuring tube 111 has an end portion with a measuring tube bend at the end, which a short straight portion for fastening in the bore of a support body (not shown here) adjoins. The measuring tube 111 has an end portion 141 polished by forced plasma polishing which extends in the longitudinal direction from an end face of the measuring tube or the support body to approximately the middle of the end bend 141, which is followed by an etched portion 143 which in turn merges into an electropolished portion 145 which here extends approximately up to half of a straight portion of the measuring tube 111 between the end measuring tube bend and the middle measuring tube bend.
For comparison, FIG. 2b shows a portion of a measuring tube 211 which is not polished by forced plasma polishing and is therefore not according to the invention. The measuring tube 211 has the same arrangement with respect to its components as the measuring tube according to the invention. It therefore also has an exciter holder 230 for an electrodynamic exciter in the apex of a central measuring tube bend, wherein a measuring tube cross-sectional plane runs through the holder 230, to which plane the measuring tube 211 has a mirror-symmetrical course. The measuring tube arrangement further comprises two electrodynamic vibration sensors (not shown here), which are arranged symmetrically to the measuring tube cross-sectional plane, and of which a first sensor holder 231 for holding a first of the electrodynamic vibration sensors is shown in FIG. 2b. The measuring tube 211 has an end portion with a measuring tube bend at the end, to which a short straight portion is connected for fastening in the bore of a support body (not shown here). The measuring tube 211 has a short plasma-polished end portion 241, which extends in the longitudinal direction from an end face of the measuring tube or the support body only over approximately one measuring tube diameter, which is followed by an etched portion 243, which in turn merges into an electropolished portion 245, which here only extends approximately to the end of the end measuring tube bend.

From the comparison of FIGS. 2a and 2b it follows that the forced plasma-polished portion 141 of the measuring tube arrangement according to the invention extends considerably further into the measuring tube 111 than the non-forced plasma polished portion 241 into the measuring tube 211 of the comparative measuring tube arrangement. The same applies to the extension of the electropolished portion 145 in the longitudinal direction of the measuring tube 111.

With reference to FIGS. 3a and 3b, aspects of forced plasma polishing are now explained. During the forced plasma polishing, an electrolyte having a temperature of, for example, not less than about 80° C. flows through the measuring tube arrangement to be treated, wherein a polishing voltage is applied between a central cathode and the tube, in particular the measuring tube, which is sufficient to form a plasma, for example 350 V. When the plasma is formed, a gas bubble film is formed on the surface of the measuring tube arrangement, which, due to its electrical resistance, limits the current density in the region of the plasma. The flowing electrolyte continuously carries away larger bubbles and waste from the polishing process, so that the conditions of the plasma polishing are kept stable in a region 41 which corresponds to the forced plasma-polished region of the measuring tube arrangement. As the distance from the central cathode increases, the field strength decreases, so that beyond a certain distance the plasma can no longer be maintained. This eliminates the electrical resistance of the gas bubble film and, as shown in FIG. 3a, a significantly higher current density peak occurs, which can lead in particular to the etching free of the microstructure in an etched portion 43. With increasing distance from the central cathode, the field strength continues to decrease, which also results in a current density that decreases with distance. This results in an in particular continuous transition to conventional electropolishing of the surface, wherein the quality of the electropolishing decreases with the distance, i.e., the roughness increases with the distance to the cathode. The resulting course of the roughness in the longitudinal direction of a measuring tube arrangement is shown schematically as a solid line in FIG. 3b for a measuring tube arrangement polished by forced plasma polishing. The low roughness in the plasma-polished region 41 is followed by an etched portion 43 with etching down to the grain boundaries of the microstructure, which, at a distance from the cathode, merges into an electropolished portion 45 with a roughness that is increased compared to the plasma-polished region 41. For example, the plasma-polished portion has a surface roughness of no more than Ra=0.3 μm. The electropolished region 45 has a roughness of, for example, 0.8 μm to 1 μm.

The dot-dash line in FIG. 3b shows the resulting roughness after treatment of the measuring tube arrangement when the electrolytes are stationary, wherein this, together with an electrolyte temperature of 80° C. and an applied polishing voltage, also leads to the formation of a plasma. However, the lack of electrolyte flow prevents stable conditions at a voltage similar to that used in forced plasma polishing, since the transport of bubbles and removed material is eliminated. As a result, the plasma can only be maintained in a stable manner over a comparatively short distance. The sequence of the different regions is similar to that after forced plasma polishing, but the extension of the plasma-polished region in the longitudinal direction of the measuring tube arrangement is now considerably shortened, as has already been explained on the basis of the sectional views in FIGS. 2a and 2b.

In comparison, the dotted line in FIG. 3b shows the roughness progression along the measuring tube arrangement when treated by pure electropolishing. In this case, the roughness increases with increasing distance from a central cathode.

What all examples in FIG. 3b have in common is that the cathode was positioned with its cathode tip close to an end face of the support body facing away from the tube, in particular the measuring tube, i.e., at most protruding only very slightly into the bore of the support body or into the tube, in particular the measuring tube.

An embodiment of a suitable arrangement 350 for forced electropolishing is outlined in FIG. 4, wherein the arrangement 350 has a central pin-shaped stainless steel cathode 358 which is held by means of a drilled disk 352 in a cylindrical electrolyte line 354 on its longitudinal axis. The electrolyte line 354 has a connection device 355 at its end, wherein an O-ring 356 is axially clamped in a fluid-tight manner between an end face of the connection device 355 and an end face of a support body 321 of a measuring tube arrangement 301 to be treated. A measuring tube 311 of the measuring tube arrangement is fixed in a through-bore 323 of the support body 321. The support body can in particular be the distributor piece of a Coriolis mass flow measuring sensor. In this embodiment, the electrolyte line and the cathode are positioned in front of the end face of the support body 323. However, this is not essential to the invention. There are designs in which the forced plasma polishing starts directly on the end face of the measuring tube. Only after the forced plasma polishing is a process connection mounted on the measuring tube arrangement. In such an embodiment, the electrolyte line and the cathode are to be positioned on the end face of a measuring tube, as shown in FIG. 6a. During the plasma polishing of a measuring tube arrangement 501, an electrolyte line 554 and a cathode 558 are positioned on the end face of a measuring tube 511 which protrudes from a support body 521. After the plasma polishing according to the invention, a process connection flange 527 is mounted on the measuring tube arrangement.

We now turn again to FIG. 4. During the forced plasma polishing, the measuring tube arrangement is connected to circuit ground, wherein a polishing voltage Up of, for example, 350 V is applied to the cathode, wherein an electrolyte preheated to, for example, 80° C. is conveyed through the electrolyte line so that it fills the measuring tube or tubes of the measuring tube arrangement with a volume flow rate per cross-sectional area of the measuring tube arrangement through which a flow can pass of for example, 0.3 l/(min. cm²). Due to the positioning of the cathode 358 in front of the measuring tube arrangement 301, the field distribution, formation of the plasma and the transport of polishing waste are not affected in any way by solid bodies such as the cathode or its supply line. This is a significant advantage, especially in the case of measuring tubes with small diameters or curved measuring tubes. In addition, the forced plasma polishing covers a region of the measuring tube arrangement 301 that extends from the end face of the support body 321 into the measuring tube 311 and thus largely corrects impairments of the surface quality that may have occurred, for example, by fastening the measuring tubes in the bores or by bending the measuring tubes.

If the arrangement has a single cathode, this can be positioned in the region of the support body in accordance with a symmetry of the measuring tube arrangement, i.e., in a plane of symmetry, at the intersection of two planes of symmetry, or on an axis of rotational symmetry. If multiple cathodes are provided, all the cathodes should have a symmetry that follows the symmetry of the support body of the measuring tube arrangement. For example, in each case a cathode can be arranged on the axis of a bore for receiving a measuring tube.

Finally, the method steps of an embodiment 400 of the method according to the invention are discussed with reference to FIG. 5.

The method begins with positioning 410 a cathode and an electrolyte supply line with respect to a measuring tube arrangement, wherein the cathode has a tip that is positioned, for example, approximately in the plane of an end face of the measuring tube arrangement.

This is followed by allowing an electrolyte to flow 420 through the measuring tube arrangement at a flow rate of, for example, 8 cm/s, wherein the electrolyte is conveyed through the electrolyte supply line and is heated to a temperature of approximately 80° C., and wherein the electrolyte comprises an ammonium sulfate solution to which sulfuric acid is added. The conductivity of the electrolyte is not more than, for example, 350 mS/cm. With such limited conductivity, it is ensured that the electrical potential required for plasma polishing is not dissipated over too short a distance

When electrolyte is flowing, the application 430 of an electrical polishing voltage Up of, for example, 350 V between the cathode and the measuring tube arrangement follows, which is sufficient to maintain a plasma in a portion of the measuring tube arrangement that extends over several inner diameters of the measuring tube into the measuring tube arrangement. By applying the electrical polishing voltage, a plasma with a layer of gas bubbles is created on the surface of the measuring tube arrangement, which is stabilized by the flowing electrolyte, wherein surface defects of the measuring tube arrangement are eliminated by the plasma polishing. As explained above, the plasma collapses at some distance from the cathode because the field strength there is not sufficient to maintain the plasma. Since the gas layer is thus lost as an electrical resistance, high current densities occur here in a locally limited region, which cause the grain boundaries of the microstructure to be etched free. In the adjoining region of lower remaining field strengths, quasi conventional electropolishing follows, the effectiveness of which decreases with the distance from the cathode, as explained above.

For measuring tube arrangements with a measuring tube inner diameter of no more than 1 cm, the end of the polishing time is reached after 5 minutes, for example, because in the region polished by forced plasma polishing a sufficiently good surface quality with, for example, a roughness Ra<0.4 μm is achieved.

This is followed by a final treatment 450, which in particular comprises rinsing the measuring tube arrangement in order to remove the electrolyte without leaving any residue.

1-14. (canceled)

15. A measuring tube arrangement, comprising:
two support bodies, each with at least one bore; and
at least one tube with a lumen for guiding a medium,
wherein the at least one tube has a first end portion and a second end portion which are each connected to one of the support bodies,
wherein the at least one bore of each of the support bodies communicates with one another via the lumen of the at least one tube,
wherein the measuring tube arrangement has a portion which is polished by forced electrolytic plasma polishing and which, in a region in which a flow cross section has not more than a cross section of the at least one tube, extends over at least three diameters of the at least one tube, and
wherein the portion polished by forced plasma polishing is followed by an etched portion that has a different surface structure from the portion polished by forced plasma polishing.

16. The measuring tube arrangement according to claim 15, wherein the portion polished by forced plasma polishing has a surface roughness Ra which is not more than Ra=0.4 μm.

17. The measuring tube arrangement according to claim 15, wherein the at least one tube has a metal structure, and wherein the etched portion has a surface structure in which grain boundaries of the metal structure are etched free.

18. The measuring tube arrangement according to claim 15,
wherein the at least one tube has a curved course at least in portions with at least one arc that sweeps over an angle of not less than 20°,
wherein the at least one arc has a radius of curvature of not more than 10 inner diameters of the at least one tube, and
wherein the portion polished by forced plasma polishing includes the at least one arc over at least half a length of the at least one arc.

19. The measuring tube arrangement according to claim 18, wherein the inner diameter of the at least one tube is not more than 30 mm.

20. A measuring sensor, comprising:
a measuring tube arrangement, including:
two support bodies, each with at least one bore; and
at least one tube with a lumen for guiding a medium,
wherein the at least one tube has a first end portion and a second end portion which are each connected to one of the support bodies,
wherein the at least one bore of each of the support bodies communicates with one another via the lumen of the at least one tube,
wherein the measuring tube arrangement has a portion which is polished by forced electrolytic plasma polishing and which, in a region in which a flow cross section has not more than a cross section of the at least one tube, extends over at least three diameters of the at least one tube, and
wherein the portion polished by forced plasma polishing is followed by an etched portion that has a different surface structure from the portion polished by forced plasma polishing;
a base body that connects the two support bodies to one another in a rigid manner;
an electrodynamic exciter for exciting bending vibration modes; and
at least one vibration sensor for detecting bending vibrations of the at least one tube.

21. The measuring sensor according to claim 20, wherein the measuring tube arrangement includes two parallel measuring tubes, wherein the electrodynamic exciter is configured to excite bending vibrations in at least one bending vibration mode between the measuring tubes, and wherein the at least one vibration sensor is configured to detect bending vibrations between the measuring tubes.

22. A method for a portion-wise plasma polishing of a measuring tube arrangement, comprising:
positioning a cathode and an electrolyte supply line with respect to the measuring tube arrangement, wherein the cathode has a tip which is spaced no more than four inner diameters of a measuring tube of the measuring tube arrangement from an end face of the measuring tube arrangement;
allowing an electrolyte to flow through the measuring tube arrangement; and
applying an electrical voltage between the cathode and the measuring tube arrangement which is sufficient to maintain a plasma in a portion of the measuring tube arrangement that extends from an end face of the measuring tube arrangement over a length of not less than four inner diameters of the measuring tube into the measuring tube arrangement,
wherein the measuring tube arrangement includes two support bodies, each with at least one bore; and at least one measuring tube with a lumen for guiding a medium, wherein end portions of the at least one measuring tube are each connected to one of the support bodies, wherein at least one end portion of the measuring tube is forced plasma polished.

23. The method according to claim 22, wherein the electrolyte has a volume flow rate per flowable cross-sectional area of the measuring tube arrangement that is not less than 0.1 l/(min·cm 2), and/or
wherein the electrolyte has a volume flow rate per flowable cross-sectional area of the measuring tube arrangement of not more than 4 l/(min·cm 2).

24. The method according to claim 22, wherein the applied voltage is not less than 250 V, and/or wherein the applied voltage is not more than 500 V.

25. The method according to claim 22, wherein the electrolyte flows through the measuring tube at a temperature of not less than 70° C.

26. The method according to claim 22, wherein the plasma is maintained, when electrolyte is flowing, for a time period of not less than 2 minutes; and/or
wherein the plasma is maintained, when electrolyte is flowing, for a time period of not more than 10 minutes.

27. The method according to claim 22, wherein the electrolyte includes ammonium sulfate and optionally sulfuric acid.

28. The method according to claim 22, wherein the electrolyte has a conductivity of not more than 500 S/cm.
